(19) United States
(12) Patent Application Publication
(10) Pub. No.: US 2025/0261054 A1
(43) Pub. Date: Aug. 14, 2025

(54) SUPPORTING CELL RESELECTION WITH SLICES IN WIRELESS NETWORK

(71) Applicant: SAMSUNG ELECTRONICS CO., LTD., Suwon-si, Gyeonggi-do (KR)

(72) Inventors: Sangyeob JUNG, Suwon-si (KR); Aby Kanneath ABRAHAM, Bangalore (IN)

(21) Appl. No.: 18/859,484

(22) PCT Filed: Apr. 24, 2023
(86) PCT No.: PCT/KR2023/005547

§ 371 Date: Oct. 23, 2024

(30) Foreign Application Priority Data
Apr. 23, 2022 (IN) 202241024017
Apr. 11, 2023 (IN) 202241024017

(51) Int. Cl. H04W 36/00; H04W 36/08

(52) U.S. Cl. CPC H04W 36/0061; H04W 36/08

(57) ABSTRACT

The present disclosure provides a method performed by a terminal in a wireless communication system. The method includes receiving, from a base station, a system information block comprising first information indicating cell reselection priorities for slicing; and determining a frequency for a cell reselection associated with a slice based on the first information, wherein the first information indicates the frequency for the slice implicitly.

### TECHNICAL FIELD

The present disclosure relates to a wireless communication network, and more specifically related to a method and a User Equipment (UE) for supporting cell reselection with slices in the wireless communication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Most prominent feature of fifth generation (5G) networks lies in adopting network slicing for radio access networks (RANs) and core networks (CNs). The network slicing is intended for bundling up network resources and network functions into a single independent network slice depending on individual services, allowing for application of network system function and resource isolation, customization, independent management and orchestration to mobile communication network architectures. The use of the network slicing enables offering 5G services in an independent and flexible way by selecting and combining 5G system network functions according to services, users, business models, or such references.

### DISCLOSURE OF INVENTION

### Technical Problem

Conventional methods are not efficient in a specific signaling process, etc., so a more effective method for supporting cell reselection with slices is needed.

The principal objective of the embodiment herein is to discloses a method and UE for supporting cell reselection with slices in a wireless network.

Another object of the embodiment herein is to provide a frequency associated with the slice information through a RRC signalling. The method uses a DL implicit frequency by linking a frequency used to NR-ARFCN provided in a SIB2 and a SIB4.

Yet another object of the embodiment herein is to provide a network that configures DL implicit frequency in a SIB16 and an explicit DL frequency.

Yet another object of the embodiment herein is to associate tracking area to the slice information and acquire a SIB16.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Accordingly, the embodiment herein is to provide a method for supporting cell reselection with slices in a wireless network. The method includes receiving, by a UE, slice information lists associated with a carrier frequency from a network device in the wireless network. Further, the method includes detecting, by the UE, whether the carrier frequency associated with the slice information list is a downlink (DL) implicit carrier frequency or a DL explicit carrier frequency. The DL implicit carrier frequency comprises a frequency index indicating position of the DL carrier frequency received in a system information, and the DL explicit carrier frequency comprises an absolute radio-frequency channel number (ARFCN) value. In an embodiment, the method includes determining the carrier frequency based on the frequency index indicating position of the DL carrier frequency received in the system information when the DL implicit carrier frequency is detected. In another embodiment, the method includes determining the carrier frequency based on the ARFCN value when the DL explicit carrier frequency is detected.

In an embodiment, the frequency index includes value 0 and value 1 in which the value 0 corresponds to a serving frequency and the value 1 corresponds to a first frequency indicated by an InterFreqCarrierFreqList in a SIB4 message, and value 2 corresponds to a second frequency indicated by the InterFreqCarrierFreqList in a SIB4 message and so on, when the carrier frequency is the DL implicit carrier frequency.

In an embodiment, the DL explicit carrier frequency includes a DL New Radio ARFCN (NR-ARFCN) of a downlink carrier to which slice information list is associated and is explicitly provided.

In an embodiment, the DL explicit carrier frequency is received in a radio resource control (RRC) Release and the DL implicit carrier is received in the system information.

In an embodiment, the method includes receiving, by the UE, the slice information lists mapped to a tracking area. Further, the method includes applying, by the UE, the slice information list from mapped to a tracking area code of a serving cell for deriving a slice based cell reselection priority.

In an embodiment, the method includes determining, by the UE, whether the UE is in a camped normally state or camped on any cell state. Further, the method includes acquiring, by the UE, SIB16 when the UE is in camped normally state, and skipping acquisition of the SIB16 when the UE is camped on any cell state.

Accordingly, the embodiment herein is to provide a UE for supporting cell reselection with slices in a wireless network. The UE includes a supporting cell reselection controller communicatively connected to a memory and a processor. The supporting cell reselection controller receives slice information lists associated with a carrier frequency from a network device in the wireless network. Further, the supporting cell reselection controller detects whether the carrier frequency associated with the slice information list from is a DL implicit carrier frequency or a DL explicit carrier frequency. The DL implicit carrier frequency includes a frequency index indicating position of the DL carrier frequency received in a system information, and the DL explicit carrier frequency comprises an ARFCN value. In an embodiment, the supporting cell reselection controller determines the carrier frequency based on the frequency index indicating position of the DL carrier frequency received in the system information when the DL implicit carrier frequency is detected. In another embodiment, the supporting cell reselection controller determines the carrier frequency based on the ARFCN value when the DL explicit carrier frequency is detected.

In an embodiment, the UE is configured with multiple slice information lists (sliceInfoList), each sliceInfoList is associated to a tracking area code (or a tracking area identifier).

In an embodiment, when the UE has received multiple sliceInfoLists and each sliceInfoLists is mapped to different tracking areas, the UE applies the sliceInfoList mapped to the tracking area code of a serving cell for deriving the slice based cell reselection priorities. The UE applies the sliceInfoList mapped to the tracking area code of the serving cell even when the slicegroup is not supported by the serving cell and is supported only by a neighboring cell for deriving the slice based cell reselection priorities.

In an embodiment, the UE acquires SIB16 when the UE is in a camped normally state. when the UE moves to camped on any cell state, the UE doesn't read SIB16. i.e. when the UE in RRC_IDLE or RRC_INACTIVE and is in camped normally state, the UE acquires SIB16.

In an embodiment, the UE can be configured with a frequency index associated to a slice information list (FreqPriorityListNRSlicing). Frequency index indicates the position of the frequency in system information.

Accordingly, the embodiment herein is to provide a method for supporting cell reselection with slices in a wireless network. The method includes sending, by a network device, at least one slice information list associated with at least one carrier frequency to a UE in the wireless network. Further, the method includes indicating, by the network device, the UE whether the network device configures the UE through a DL implicit carrier frequency by providing an index to a system information position or a DL explicit carrier frequency by providing a ARFCN value. The DL implicit carrier frequency or the DL explicit carrier frequency is associated to the at least one slice information list.

Accordingly, the embodiment herein is to provide a network device for supporting cell reselection with slices in a wireless network. The network device includes a supporting cell reselection controller communicatively connected to a memory and a processor. The supporting cell reselection controller is configured to send at least one slice information list associated with at least one carrier frequency to the UE in the wireless network. Further, the supporting cell reselection controller is configured to indicate the UE whether the network device configures the UE through a DL implicit carrier frequency by providing an index to a system information position or a DL explicit carrier frequency by providing a ARFCN value. The DL implicit carrier frequency or the DL explicit carrier frequency is associated to the at least one slice information list.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

The present disclosure provides an effective and efficient method for supporting cell reselection with slices. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The method and the UE supporting cell reselection with slices in wireless network are illustrated in the accompanying drawings, throughout which like reference letters indicate corresponding parts in the various figures. The embodiments herein will be better understood from the following description with reference to the drawings, in which:

FIG. 1 illustrates a schematic view of a wireless network for supporting cell reselection with slices, according to the embodiments as disclosed herein;

FIG. 2 is a flow chart illustrating a method for supporting the cell reselection with slices in the wireless network, according to the embodiments as disclosed herein;

FIG. 3 is a flow chart illustrating a scenario of handling slice information lists mapped to different tracking areas, according to the embodiments as disclosed herein;

FIG. 4 is a flow chart illustrating an alternate scenario of handling slice information lists mapped to the different tracking areas, according to the embodiments as disclosed herein;

FIG. 5 is a flow chart illustrating a scenario of handling slice information lists mapped to a different PLMN, according to the embodiments as disclosed herein;

FIG. 6 is a flow chart illustrating a scenario of handling cell reselection priorities in camped on any cell state, according to the embodiments as disclosed herein;

FIG. 7a and FIG. 7b are flow charts illustrating a method for acquiring SIB16, according to the embodiments as disclosed herein;

FIG. 8 illustrates a sequential diagram of a system information acquisition, according to the embodiments as disclosed herein;

FIG. 9 is a flow chart illustrating a cell reselection Priority derivation when NSAG information is deleted, according to the embodiments as disclosed herein;

FIG. 10 is a flow chart illustrating a method for receiving DL Carrier Frequency in sliceinformation list, according to the embodiments as disclosed herein;

FIG. 11 is a flow chart illustrating a scenario of handling of implicitly received DL Carrier Frequency in sliceinformation list, according to the embodiments as disclosed herein; and

FIG. 12 is a flow chart illustrating a method for supporting cell reselection with slices in the wireless network, according to the embodiments as disclosed herein

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

From technical specification (TS) 38.300 Release 16 of 3rd Generation Partnership Project (3GPP), the network slice always includes a RAN part and a CN part. The support of the network slicing relies on a principle that traffic for different slices is handled by different Protocol Data Unit (PDU) sessions. The network can realise the different network slices by scheduling and also by providing different layer 1/layer 2 (L1/L2) configurations. The network slicing is a concept to allow differentiated treatment depending on each customer requirements. With the network slicing, it is possible for Mobile Network Operators (MNO) to consider customers as belonging to different tenant types with each having different service requirements that govern in terms of what slice types each tenant is eligible to use based on a service level agreement (SLA) and subscriptions.

Some slices may be available only in part of the wireless network. A new radio radio-access network (NG-RAN) supported Single-Network Slice Selection Assistance Information (S-NSSAI(s)) is configured by an Operations, Administration and Maintenance (OAM) entity. Awareness in the NG-RAN of the slices supported in the cells of its neighbours may be beneficial for inter-frequency mobility in a connected mode. It is assumed that the slice availability does not change within a UE's registration area. The NG-RAN and the 5GC (5G Core) are responsible to handle a service request for the slice that may or may not be available in a given area. Admission or rejection of an access to the slice may depend by factors such as support for the slice, availability of resources, support of the requested service by the NGRAN. In case, the UE is associated with multiple slices simultaneously, only one signalling connection is maintained and for intra-frequency cell reselection, the UE tries to camp on the best cell.

When some of the slices are supported only in some frequencies, till NR Release 16, the NR networks used, dedicated priorities to control the frequency on which the UE camps. In NR release 17, slice specific prioritization is introduced. A serving cell can broadcast slice information including the slice support in serving as well as neighboring frequencies, slice specific priorities for serving as well as neighboring frequencies, details on the slice availability in the neighboring cells etc. There may be also some frequencies which may not be associated with any slices. The UE considers the slice priorities of the slices that the UE needs/supports along with the frequency priorities for the slices during cell reselection.

According to the 3GPP specification TS 38.300, the cell reselection is the process that identifies the cell that the UE camps on when the UE is in a non-connected state (i.e. radio resource control (RRC)_IDLE and RRC_INACTIVE). It is based on cell reselection criteria. An inter-frequency reselection is based on absolute priorities where the UE tries to camp on the highest priority frequency available. The cell reselection involves measurements of the serving and neighbour cells. The cell reselection can be speed dependent and in multi-beam operations, and a cell quality is derived amongst the beams corresponding to the same cell.

From 3GPP TS 38.304, absolute priorities of different NR frequencies or inter-RAT frequencies may be provided to the UE in a system information (SIB), in a RRCRelease message (Message that releases the RRC Connection and moves the UE from RRC_CONNECTED to RRC_IDLE or RRC_INACTIVE), or by inheriting from another RAT (Radio Access Technology) at inter-RAT cell (re)selection. In the case of the system information, an NR frequency or inter-RAT frequency may be listed without providing a priority (i.e. a field cellReselectionPriority is absent for that frequency). When priorities are provided in a dedicated signalling, the UE ignores all the priorities provided in the system information. When the UE is in camped on any cell state, the UE only applies the priorities provided by system information from the current cell, and the UE preserves priorities provided by dedicated signalling and deprioritisationReq received in a RRCRelease unless specified otherwise. When the UE is configured to perform NR sidelink communication or vehicle to everything (V2X) sidelink communication performs cell reselection. The UE may consider the frequencies providing the intra-carrier and inter-carrier configuration have equal priority in cell reselection.

Absolute priorities are used during cell reselection mainly as below scenario:

When a neighbor frequency has lower or equal priority than the serving frequency, the UE measures the frequencies for the cell reselection only when the serving cell goes below certain threshold decided by the wireless network. When the neighbor frequency has higher priority than the serving frequency then the UE measures those frequencies irrespective of serving frequency thresholds. The UE may further relax measurements based on a mobility of the UE or based on a distance of the UE from the serving cell. The network provides thresholds and conditions for the UE to relax measurements. The conditions can be different for low priority and high priority frequencies.

The UE performs cell reselection evaluation based on different thresholds and different conditions depending on whether a neighbor frequency is having lower/equal/higher priority than the serving frequency. When there are multiple neighbor cells that satisfy cell reselection evaluation criteria, the UE reselects to the neighboring cells belonging to the higher priority frequency.

When the UE is camped normally, the UE executes the cell reselection evaluation process on the following triggers:

The UE internal triggers, so as to meet performance requirements.

When information on the system information used for the cell reselection evaluation procedure has been modified.

In slice aware cell reselection, network Slice AS Groups (NSAG)/Slice Groups are used. The NSAG or the slice group is a group which is associated to the one or more slices. When the UE has indicated that the UE supports NSAG or NSAG based slice reselection, the Access & Mobility Management Function (AMF) entity may configure the UE with NSAG information for one or more S-NSSAIs (Single Network Slice Selection Assistance Information) in the configured NSSAI, by including the NSAG information in a registration accept message or a UE configuration command message. The AMF entity indicates in the NSAG Information in which a specific NSAG association to S-NSSAI(s) is valid in a tracking area (TA, a group of cells) when the AMF entity provides, in the UE configuration, a NSAG value which is used in different TAs (Tracking Areas) with a different association with the NSSAIs. The UE configuration of the AMF provides at least the NSAGs for the UE for the TAs of the registration area.

The UE stores and considers the received NSAG Information, valid for a registered Public Land Mobile Network (PLMN) until:
the UE receives new NSAG information in a registration accept message or a UE configuration command message in the PLMN; or
the UE receives a Configured NSSAI without any NSAG information in the PLMN.

The NR UE RRC may receive slicegroup, and/or slice priority-priority associated with the slice from a Non-access stratum (NAS) layer. The NR UE RRC also may receive a list of sliceInformation, sliceInfo including an identifier for a slice (or a group of slices known as slicegroup) and a list of frequencies and the priority applicable for individual frequencies for the slice. There can be frequencies without priorities in the sliceInfo and such slices/slice groups may be considered as lowest frequency priority for the slice/slice group. Below extracts from NR RRC 17.0.0 illustrates the structure:

```
  ASN1START
  TAG-FREQPRIORITYLISTNRSLICING-START
  FreqPriorityListNRSlicing-r17 ::= SEQUENCE (SIZE (0..maxFreq)) OF FreqPriori-
tyNRSlicing-r17
  FreqPriorityNRSlicing-r17 ::= SEQUENCE {
  sliceInfoList-r17 SliceInfoList-r17 OPTIONAL, -- Need R
  ...
  }
  SliceInfoList-r17 ::= SEQUENCE (SIZE (1..maxSliceInfo-r17)) OF SliceInfo-r17
  SliceInfo-r17 ::= SEQUENCE {
  sliceGroupID-r17 SliceGroupID-r17,
  cellReselectionPriority-r17 CellReselectionPriority OPTIONAL, -- Need R
  cellReselectionSubPriority-r17 CellReselectionSubPriority OPTIONAL, -- Need R
  sliceCellListNR-r17 CHOICE {
  sliceAllowCellListNR-r17 SliceCellListNR-r17,
  sliceExcludeCellListNR-r17 SliceCellListNR-r17
  } OPTIONAL, -- Need R
  ...
  }
  SliceGroupID-r17 ::= BIT STRING (SIZE(8)) -- The size is FFS, depends on slice
group granulartiy
  SliceCellListNR-r17 ::= SEQUENCE (SIZE (1..maxCellSlice-r17)) OF PCI-Range
  TAG-FREQPRIORITYLISTNRSLICING-STOP
  ASN1STOP
```

TABLE 1

FreqPriorityListNRSlicing field descriptions
FreqPriorityListNRSlicing
Indicates the list of frequency priority information
for frequencies. The 1^{st} entry in the
list corresponds to the current frequency
(referring SIB2), the 2^{nd} entry in the list
corresponds to the first frequency indicated by
the InterFreqCarrierFreqList in SIB4, and
the 3^{rd} entry in the list corresponds to the
second frequency indicated by the InterFreq-
CarrierFreqList in SIB4, and so on.
sliceAllowCellListNR
Indicates the list of allow-listed neighbouring
cells for slicing. If present, cells not
listed in the list do not support the
corresponding sliceGroup-frequency pair.
sliceCellListNR
Indicates the list of allow-list or exclude-listed
neighbour cells for slicing. If sliceInfo-
r17 corresponds to the current frequency,
the field should be absent. FFS if the field
can be provided in RRCRelease.
sliceExcludeCellListNR
Indicates the list of exclude-listed neighbouring
cells for slicing. If present, cells not
listed in the list support the corresponding
slice sliceGroup-frequency pair.

When the UE performs slice based cell reselection, the priority used for cell reselection is a combination of both slice priority/NSAG priority received from the NAS layer and frequency priority received from the RRC.

There are two ways by which sliceInformation (for e.g. FreqPriorityNRSlicing) can be received by the UE (such as one way is broadcast signaling (i.e., System Information Block 16,SIB16) and other way is a dedicated signalling in RRC messages like RRC release).

SIB16 structure is given as below:

```
  ASN1START
  TAG-SIB16-START
  SIB16-r17 ::= SEQUENCE {
  freqPriorityListNRSlicing-r17 FreqPriorityListNRSlicing-r17 OPTIONAL, -- Need
R
  lateNonCriticalExtension OCTET STRING OPTIONAL,
  ...
  }
  TAG-SIB16-STOP
  ASN1STOP
  The RRC Release may include cellReselectionPriorities as below.
  CellReselectionPriorities ::= SEQUENCE {
  freqPriorityListEUTRA FreqPriorityListEUTRA OPTIONAL, -- Need M
  freqPriorityListNR FreqPriorityListNR OPTIONAL, -- Need M
  t320 ENUMERATED {min5, min10, min20, min30, min60, min120, min180,
spare1} OPTIONAL, -- Need R
  ...,
  [[
  freqPriorityListNRSlicing-r17 FreqPriorityListNRSlicing-r17 OPTIONAL -- Need
M
  ]]
  }
```

In slice aware cell reselection procedure, as per 3GPP Release 17.0.0 TS 38.304 specification, the UE derives slice specific cell reselection priorities when the UE performs slice based cell reselection as below. The UE derives re-selection priorities for slice-based cell re-selection by using:
a) a list of prioritized slice groups (NSAG) provided by NAS in priority order,
b) sliceInformation per frequency with sliceSpecificCellReselectionPriority per slice group, when provided system information and/or dedicated signalling,
c) cellReselectionPriority per frequency provided in system information and/or dedicated signalling.

The UE considers an NR frequency to support a slice group when the NR frequency is included in sliceInformation and indicates support for the slice group.

The UE considers a cell on an NR frequency to support a slice group when
a) the NR frequency is included in sliceInformation and supports the said slice group;
b) the cell is either listed in the sliceAllowCellListNR (if provided in system information of the serving cell and/or dedicated signalling); or
c) the cell is not listed in the sliceExcludeCellListNR (if provided in system information of the serving cell and/or dedicated signalling).

The UE derives re-selection priorities for slice-based cell re-selection according to the following rules/procedures:
a) Frequencies that support a prioritized slice group received from the NAS have higher re-selection priority than frequencies that support no prioritized slice groups.
b) Frequencies that support the slice group are prioritized in the order of the NAS-provided priority for the highest prioritized slice group of the frequency.
c) Among the frequencies that support the same highest prioritized slice group, the frequencies are prioritized in the order of their per slice group sliceSpecificCellReselectionPriority.
d) Frequencies that support a prioritized slice group and that indicate per slice group sliceSpecificCellReselectionPriority have higher re-selection priority than frequencies that support the prioritized slice group without indicating per slice group sliceSpecificCellReselectionPriority.
e) Frequencies that support no prioritized slice group are prioritized in the order of their cellReselectionPriority.

For the UE performing slice-based cell reselection when a cell fulfils the above criteria for the cell reselection based on re-selection priority for the frequency and slice group derived according to above rules, but the cell does not support the slice group based on above conditions, the UE re-derives a re-selection priority for the frequency by considering the slice group(s) supported by the cell (rather than those of the corresponding NR frequency) according to clause above rules. The reselection priority is used until the highest ranked cell changes on the frequency, or new slice or slice group priorities are received from NAS. The UE ensures the cell reselection criteria above are fulfilled based on the newly derived priorities.

### Problem Statement:

1. A slice (identified by the NSSAI) may be associated with different slice groups (NSAGs) in the different tracking areas (TA) within the same registration area (RA). But, in the current 3GPP specifications, there is no way by which a gNB can configure the UE with different sliceInformation for the different tracking areas.
2. Once the UE can be configured with different sliceInformation (i.e., freqPriorityListNRSlicing) for different tracking areas, the user of the UE or an operator needs to define methods by which the UE applies the information. In an example, the UE may be configured with different sliceInformation like slice specific frequency priorities for the serving cell and different neighbor cells when they are in different Tracking areas. The UE need to be aware which frequency priority to be used in such cases.
3. When the UE is in camped on any cell state, the UE may receive both slice specific cell reselection information and the normal (non-slice) cell reselection priorities from the network. There needs to have a method to distinguish between the same.
4. The UE gets the slice Information from the SIB16. It needs to be defined how the UE acquires SIB16 for acquiring slice information.
5. Needs method to handle the case where the UE RRC has re-derived priorities as the best cell is not supporting one or more of the NSAGs, and then the UE RRC receives information that slice priorities are deleted from the NAS.
6. In RRC v17.0.0, the FreqPriorityNRSlicing is mapped to the position of frequency in the system information. Since all the NR frequencies may not support slicing, the FreqPriorityNRSlicing is inefficient while broadcasting. Similarly there is no need for providing the mapping for RRC Release and the FreqPriorityNRSlicing as it may lead to ambiguities as the indexing among SIBs may change in a new serving cell after the UE performs cell reselection. As a result, a new method to communicate the FreqPriorityNRSlicing may be preferred.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Embodiments herein disclose a method for supporting cell reselection with slices in a wireless network. The method includes receiving, by a UE, slice information lists associated with a carrier frequency from a network device in the wireless network. Further, the method includes detecting, by the UE, whether the carrier frequency associated with the slice information list is a DL implicit carrier frequency or a DL explicit carrier frequency. The DL implicit carrier frequency comprises a frequency index indicating position of the DL carrier frequency received in a system information, and the DL explicit carrier frequency comprises an ARFCN value. In an embodiment, the method includes determining the carrier frequency based on the frequency index indicating position of the DL carrier frequency received in the system information when the DL implicit carrier frequency is detected. In another embodiment, the method includes determining the carrier frequency based on the ARFCN value when the DL explicit carrier frequency is detected.

In an embodiment, the UE is configured with multiple slice information lists (i.e., sliceInfoList), where each sliceInfoList is associated to a tracking area code (or a tracking area identifier).

In an embodiment, the UE applies the sliceInfoList mapped to the tracking area code of a serving cell for deriving the slice based cell reselection priorities when UE has received multiple sliceInfoLists each mapped to different tracking areas.

In an embodiment, the UE acquires SIB16 when the UE is in camped normally state. When the UE moves to camped on any cell state, the UE doesn't read SIB16. That is, when the UE in the RRC_IDLE or RRC_INACTIVE and is in a camped normally state, the UE acquires the SIB16.

In an embodiment, the UE is configured with a frequency index associated to a slice information list (i.e., FreqPriorityListNRSlicing).

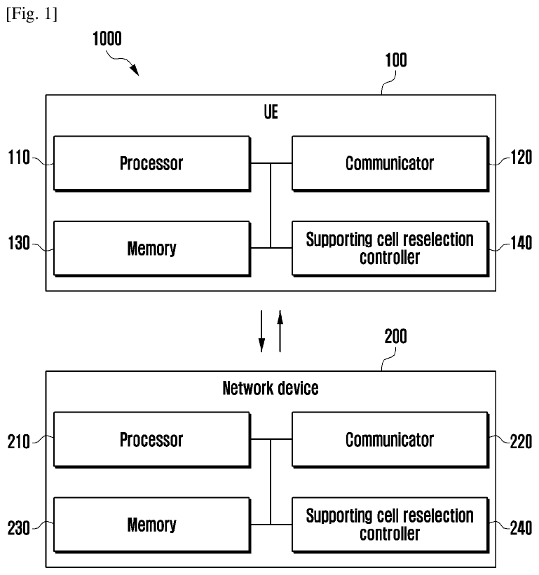

FIG. 1 illustrates a schematic view of a wireless network (1000) for supporting cell reselection with slices, according to the embodiments as disclosed herein. In an embodiment, the wireless network (1000) includes a UE (100) and a network device (200). The wireless network (1000) can be, for example, but not limited to a fourth generation (4G) network, a fifth generation (5G) network, an Open Radio Access Network (ORAN) or the like. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network device (200) can be, for example, but not limited to a gNB, a eNB, a new radio (NR) trans-receiver or the like.

In an embodiment, the UE (100) includes a processor (110), a communicator (120), a memory (130) and a supporting cell reselection controller (140). The processor (110) is coupled with the communicator (120), the memory (130) and the supporting cell reselection controller (140).

The supporting cell reselection controller (140) receives the slice information lists associated with the carrier frequency from the network device (200). Further, the supporting cell reselection controller (140) detects whether the carrier frequency associated with the slice information list is a DL implicit carrier frequency or a DL explicit carrier frequency. The DL implicit carrier frequency includes a frequency index indicating position of the DL carrier frequency received in a system information, and the DL explicit carrier frequency comprises an ARFCN value. In the frequency index, a value 0 corresponds to a serving frequency, a value 1 corresponds to a first frequency indicated by an InterFreqCarrierFreqList in a SIB4 message, and a value 2 corresponds to a second frequency indicated by an InterFreqCarrierFreqList in a SIB4 message and so on, when the carrier frequency is the DL implicit carrier frequency. Value n corresponds to the n^{th} frequency indicated by an InterFreqCarrierFreqList in a SIB4 message when n>0. The DL explicit carrier frequency includes a DL new radio ARFCN (NR-ARFCN) of a downlink carrier to which slice information list is associated and is explicitly provided. The DL explicit carrier frequency is received in a RRC Release and the DL implicit carrier is received in the system information.

In an embodiment, the supporting cell reselection controller (140) determines the carrier frequency based on the frequency index indicating position of the DL carrier frequency received in the system information when the DL implicit carrier frequency is detected. In another embodiment, the supporting cell reselection controller (140) determines the carrier frequency based on the ARFCN value when the DL explicit carrier frequency is detected.

Further, the supporting cell reselection controller (140) receives the slice information lists mapped to a tracking area. Further, the supporting cell reselection controller (140) applies the slice information list mapped to a tracking area code of a serving cell for deriving a slice based cell reselection priority.

Further, the supporting cell reselection controller (140) determines whether the UE (100) is in a camped normally state or camped on any cell state. Further, the supporting cell reselection controller (140) acquires the SIB16 when the UE (100) is in the camped normally state, and skips acquisition of the SIB16 when the UE (100) is camped on any cell state.

In an embodiment, the network device (200) includes a processor (210), a communicator (220), a memory (230) and a supporting cell reselection controller (240). The processor (210) is coupled with the communicator (220), the memory (230) and the supporting cell reselection controller (240).

The supporting cell reselection controller (240) sends at least one slice information list associated with the at least one carrier frequency to the UE (100). Further, the supporting cell reselection controller (240) indicates the UE (100) whether the network device (200) configures the UE (100) through a DL implicit carrier frequency by providing an index to a system information position or a DL explicit carrier frequency by providing a ARFCN value. The DL implicit carrier frequency or the DL explicit carrier frequency is associated to the at least one slice information list. The supporting cell reselection controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The supporting cell reselection controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in Random Access Memory (RAM) or cache).

Although the FIG. 1 shows various hardware components of the UE (100) and the network device (200) but it is to be understood that other embodiments are not limited thereon. In other embodiments, the UE (100) and the network device (200) may include less or more number of components. Further, the labels or names of the components are used only for illustrative purpose and does not limit the scope of the invention. One or more components can be combined together to perform same or substantially similar function in the UE (100) and the network device (200).

FIG. 2 is a flow chart (S200) illustrating a method for supporting the cell reselection with slices in the wireless network (1000), according to the embodiments as disclosed herein. The operations (S202-S208) are handled by the supporting cell reselection controller (140).

At S202, the method includes receiving the slice information lists associated with the carrier frequency from the network device (200). At S204, the method includes detecting whether the carrier frequency associated with the slice information list is the DL implicit carrier frequency or the DL explicit carrier frequency. The DL implicit carrier frequency includes the frequency index indicating position of the DL carrier frequency received in the system information, and the DL explicit carrier frequency comprises the ARFCN value. At S206, the method includes determining the carrier frequency based on the frequency index indicating position of the DL carrier frequency received in the system information when the DL implicit carrier frequency is detected. At S208, the method includes determining the carrier frequency based on the ARFCN value when the DL explicit carrier frequency is detected.

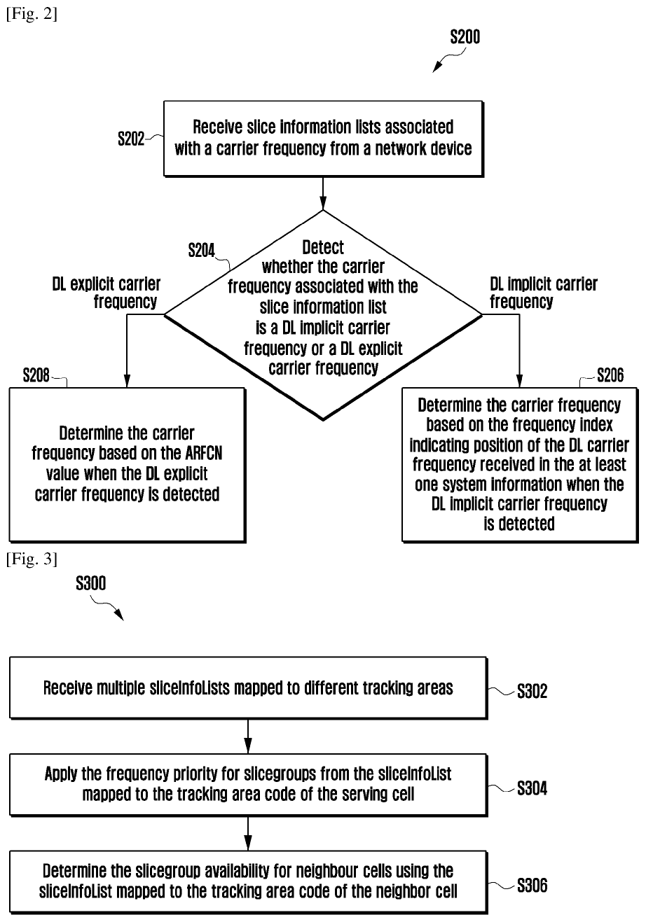

FIG. 3 is a flow chart (S300) illustrating a scenario of handling slice information lists mapped to different tracking areas, according to the embodiments as disclosed herein. The operations (S302-S306) are handled by the supporting cell reselection controller (140).

At S302, the method includes receiving the multiple sliceInfoLists mapped to the different tracking areas. At S304, the method includes applying the frequency priority for the slice groups from the sliceInfoList mapped to the tracking area code of the serving cell. At S306, the method includes determining the slicegroup availability for the neighbour cells using the sliceInfoList mapped to the tracking area code of the neighbor cell.

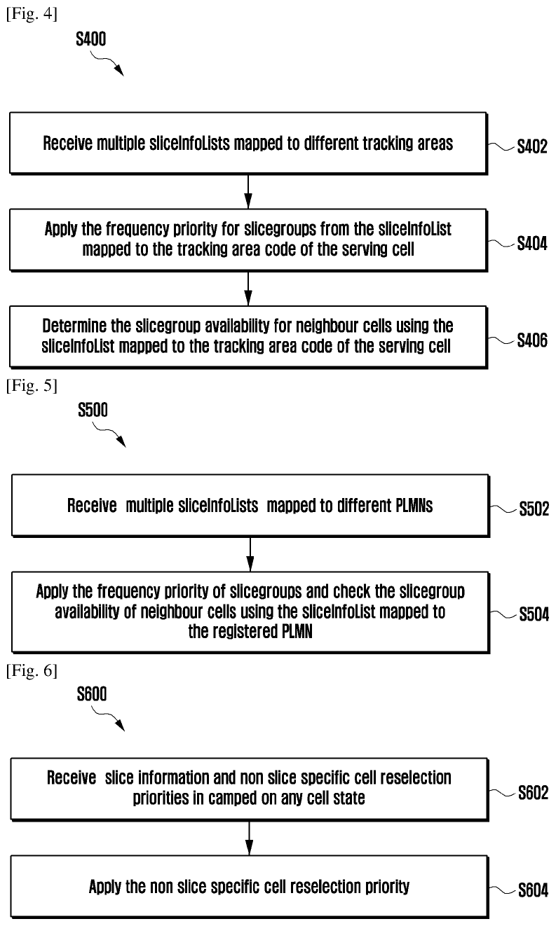

FIG. 4 is a flow chart (S400) illustrating an alternate scenario of handling slice information lists mapped to different tracking areas, according to the embodiments as disclosed herein. The operations (S402-S406) are handled by the supporting cell reselection controller (140).

At S402, the method includes receiving the multiple sliceInfoLists mapped to the different tracking areas. At S404, the method includes applying the frequency priority for slice groups from the sliceInfoList mapped to the tracking area code of the serving cell. At S406, the method includes determining the slicegroup availability for neighbour cells using the sliceInfoList mapped to the tracking area code of the serving cell.

Handling of Slice Specific Prioritization with Multiple Tracking Areas

In an embodiment, the UE (100) is configured with multiple slice information lists (i.e., sliceInfoList), each sliceInfoList associated to the tracking area code (or a tracking area identifier).

An example structure by which an gNB can send the same to the UE (100) is given below:

```
  ASN1START
  TAG-FREQPRIORITYLISTNRSLICING-START
  FreqPriorityListNRSlicing-r17 ::= SEQUENCE (SIZE (0..maxFreq)) OF FreqPriori-
tyNRSlicing-r17
  FreqPriorityNRSlicing-r17 ::= SEQUENCE {
  trackingAreaCode TrackingAreaCode OPTIONAL, -- Need R
  sliceInfoList-r17 SliceInfoList-r17 OPTIONAL, -- Need R
  ...
  }
```

In an example, when the slice information list is mapped to a tracking area code (TAC)/Tracking Area Identity (TAI), the gnb may include the list of cells that has the tracking area. The UE (100) identifies that all the slice groups mapped to the tracking area are available in the listed cells. The gNB may not broadcast allowed list or exclude list to indicate slice availability in such cases.

Further, when the UE (100) has received multiple sliceInfoLists each mapped to the different tracking areas, the UE (100) applies the sliceInfoList mapped to the tracking area code of the serving cell for deriving the slice based cell reselection priorities. The UE (100) applies the sliceInfoList mapped to the tracking area code of the serving cell even when the slicegroup is not supported by the serving cell and is supported only by the neighboring cell for deriving the slice based cell reselection priorities.

In another embodiment, when the UE (100) has received multiple sliceInfoLists, where each sliceInfoLists is mapped to different tracking areas, the UE (100) applies the sliceInfoList mapped to the tracking area code of the neighbor cell to identify whether the slice is available in the neighbor cell.

FIG. 5 is a flow chart (S500) illustrating a scenario of handling slice information lists mapped to different PLMN, according to the embodiments as disclosed herein. Similarly, when the UE (100) receives different slice information lists mapped to different PLMNs, the UE (100) applies slice information list mapped to the registered PLMN for deriving the slice.

At S502, the method includes receiving the multiple sliceInfoLists mapped to the different PLMNs. At S504, the method includes applying the frequency priority of slice groups and checking the slicegroup availability of neighbour cells using the sliceInfoList mapped to the registered PLMN.

FIG. 6 is a flow chart (S600) illustrating a scenario of handling cell reselection priorities in camped on any cell state, according to the embodiments as disclosed herein. At S602, the method includes receiving the slice information and non-slice specific cell reselection priorities in the camped on any cell state. At S604, the method includes applying the non-slice specific cell reselection priority.

Some of the above embodiments may lead to below changes in TS 38.304 specification.

TABLE 2

If the UE (100) is in camped normally state and
the UE (100) supports slice-based cell
reselection, the UE (100) derives re-selection
priorities according to clause 5.2.4.11.
The UE (100) should consider the slice
information associated with registered PLMN
(if per PLMN sliceInformation is available)
and the current serving cell's TAC (if per
TA sliceInformation is available) for deriving
reselection priorities for slice based cell
reselection.

In an embodiment, the gNB includes per TA slice Information (sliceInfoList and the associated TAC) while sending RRC Release and includes just the sliceInfoList without including TAC while sending SIB16.

### Camped on any Cell State

In an embodiment, the UE (100) is camped on any cell state, and the UE (100) has received both slice specific cell reselection information and the normal (non-slice) cell reselection priorities from the network device (200). The UE (100) applies the non-slice cell reselection priorities.

### Methods for Acquiring Slice Specific System Information

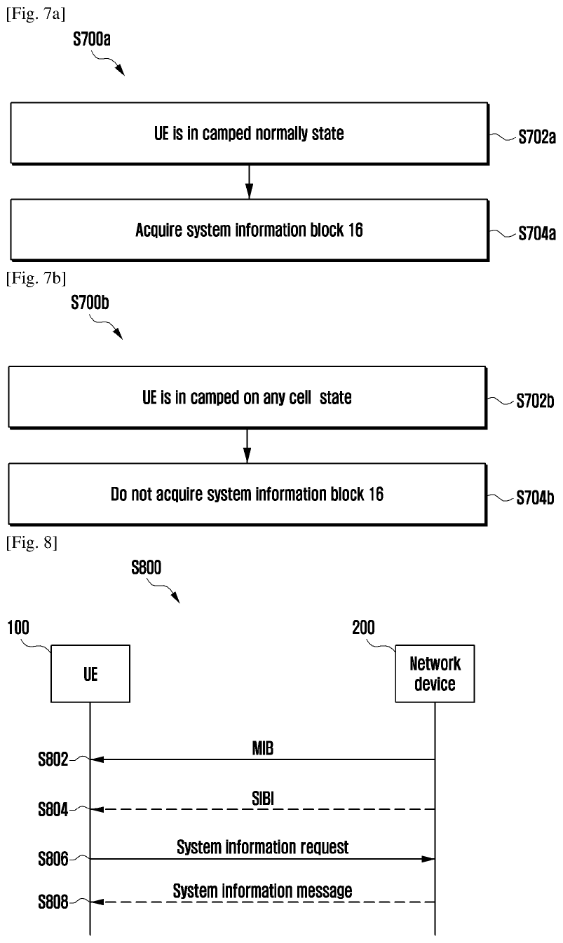

FIG. 7a and FIG. 7b are flow charts (700a and 700b) illustrates a method for acquiring SIB16, according to the embodiments as disclosed herein. In an embodiment, the UE (100) acquires the SIB16 when the UE (100) is in the camped normally state. When the UE (100) moves to camped on any cell state, the UE (100) doesn't read SIB16. That is, when the UE (100) in the RRC_IDLE or the RRC_INACTIVE and is in camped normally state, the UE (100) acquires the SIB16.

As shown in FIG. 7a, at S702a, the UE (100) is in the camped normally state. At S704a, the method includes acquiring the system information block 16. As shown in FIG. 7b, At S702b, the UE (100) is in the camped on any cell state. At S704b, the UE (100) does not acquire system information block 16.

FIG. 8 illustrates system information acquisition, according to the embodiments as disclosed herein. At S802, the network device (200) sends the MIB to the UE (100). At S804, the network device (200) sends the SIB1 to the UE (100). At S806, the UE (100) sends the system information request to the network device (200). At S808, the network device (200) sends the system information message to the UE (100).

The UE (100) applies a system information (SI) acquisition procedure to acquire an access stratum (AS), the NAS, and positioning assistance data information. The procedure applies to the UEs in the RRC_IDLE, the RRC_INACTIVE and the RRC_CONNECTED.

The UE (100) in the RRC_IDLE and the RRC_INACTIVE ensures having a valid version of (at least) the MIB, the SIB1 through the SIB4, the SIB5 (if the UE (100) supports E-UTRA), the SIB11 (if the UE (100) is configured for idle/inactive measurements), SIB12 (if the UE (100) is capable of NR sidelink communication/discovery and is configured by upper layers to receive or transmit NR sidelink communication/discovery), and SIB13, SIB14 (if the UE (100) is capable of V2X sidelink communication and is configured by upper layers to receive or transmit V2X sidelink communication), SIB16 (if the UE (100) is in camped normally state and is configured for slice specific cell reselection information), SIB19 (if the UE (100) is accessing NR via satellite access).

The UE (100) is capable of MBS broadcast which is receiving or interested to receive MBS broadcast service(s) via a broadcast MRB ensures having a valid version of SIB20 and SIB21, regardless of the RRC state the UE (100) is in. The UE (100) ensures having a valid version of the posSIB requested by upper layers.

Slice Based Cell Reselection Priority Derivation when NSAG Information is Deleted by the NAS

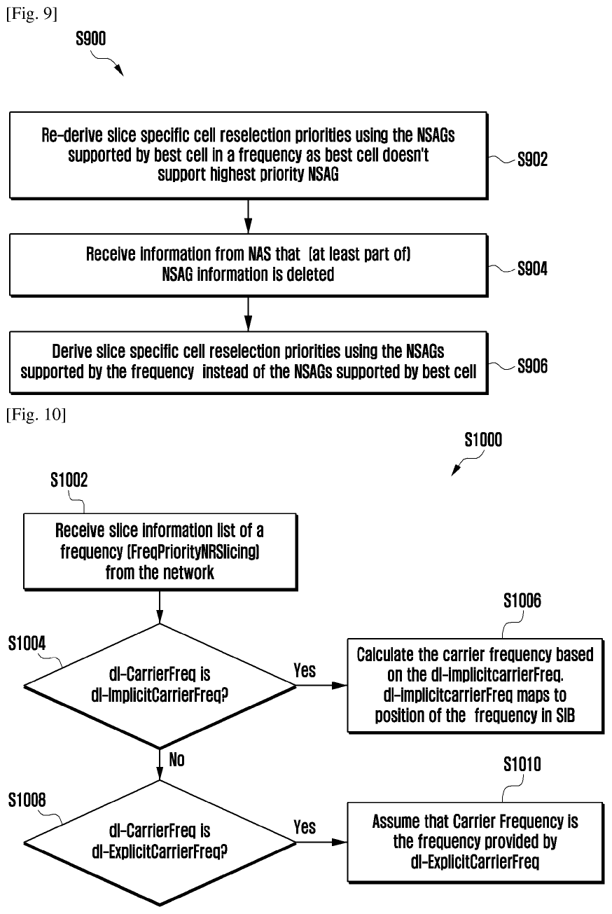

FIG. 9 is a flow chart (S900) illustrating a cell reselection priority derivation when the NSAG information is deleted, according to the embodiments as disclosed herein.

At S902, the method includes re-deriving the slice specific cell reselection priorities using the NSAGs supported by best cell in a frequency as best cell doesn't support highest priority NSAG. At S904, the method includes receiving the information from the NAS that (at least part of) NSAG information is deleted. At S906, the method includes deriving the slice specific cell reselection priorities using the NSAGs supported by the frequency instead of the NSAGs supported by the best cell.

If the UE RRC has re-derived priorities as the best cell is not supporting one or more of the NSAGs, and the UE RRC receives information that slice priorities or other NSAG information are deleted from the NAS, the UE RRC considers all the slice groups supported by the frequency rather than the slice groups supported by the best cell for deriving the slice specific cell reselection priority. In other words, the UE RRC re-derives the cell reselection priority for slice based reselection using the highest priority slice configured for the frequency rather than the highest priority slice configured by the best cell.

Methods for configuring the slice information List: In an embodiment, the UE (100) can be configured with a frequency index associated to a slice information list (FreqPriorityListNRSlicing). The frequency index indicates the position of the frequency in the system information as below.

The index value of 0 indicates the current frequency in the SIB2, index value of 1 indicates the first frequency indicated by the InterFreqCarrierFreqList in the SIB4, index value of a value of 2 indicates the second frequency indicated by the InterFreqCarrierFreqList in the SIB4, index value of a value of 3 indicates the third frequency indicated by the InterFreqCarrierFreqList in SIB4 and so on.

In an example, the structure can be represented as below:

```
  FreqPriorityListNRSlicing-r17 ::= SEQUENCE (SIZE (1..maxFreq-plus-1)) OF Fre-
qPriorityNRSlicing-r17
  FreqPriorityNRSlicing-r17 ::= SEQUENCE {
  Frequency-Index INTEGER (0..maxFreq)
  sliceInfoList-r17 SliceInfoList-r17 OPTIONAL, -- Need R
  ...
  }}
```

maxFreq is the maximum number of frequencies.

FIG. 10 is a flow chart (S1000) illustrating a method for receiving DL Carrier Frequency in the sliceinformation list, according to the embodiments as disclosed herein.

At S1002, the method includes receiving the slice information list of the frequency (i.e., FreqPriorityNRSlicing) from the network device (200). At S1004, the method includes determining whether the dl-CarrierFreq is dl-ImplicitCarrierFreq. If the dlCarrierFreq is dl-ImplicitCarrierFreq then, at S1006, the method includes computing the carrier frequency based on the dl-implicitcarrierFreq. The dl-implicitcarrierFreq maps to position of the frequency in SIB. When the dl-CarrierFreq is not dlImplicitCarrierFreq then, at S1008, the method includes determining whether the dlCarrierFreq is dl-ExplicitCarrierFreq. If dl-CarrierFreq is dl-ExplicitCarrierFreq then, at S1010, the method includes assuming that the carrier frequency is the frequency provided by dl-ExplicitCarrierFreq. The DL carrier frequency is either explicit carrier frequency or the implicit carrier frequency. It is a choice structure. If any other value (i.e., explicit carrier frequency or the implicit carrier frequency) is received, it is an error.

In another embodiment, the UE (100) is explicitly configured with the carrier frequency instead of indicating the frequency index in the system information. The network device (200) informs the UE (100) whether the network device (200) configures the UE (100) through implicit carrier frequency by providing the index to the system information position or explicit carrier frequency by providing the ARFCN value. The implicit or explicit carrier frequency can be associated to the slice information list.

An example structure can be represented as below:

```
  FreqPriorityListNRSlicing-r17 ::= SEQUENCE (SIZE (1..maxFreq-plus-1)) OF Fre-
qPriorityNRSlicing-r17
  FreqPriorityNRSlicing-r17 ::= SEQUENCE {
  dl-CarrierFreq ::= CHOICE {
  dl-ImplicitCarrierFreq INTEGER (0..maxFreq)
  dl-ExplicitCarrierFreq ARFCN-ValueNR
  }
  sliceInfoList-r17 SliceInfoList-r17 OPTIONAL, -- Need R
  ...
  }
```

The dl-ImplicitCarrierFreq indicates the position of the frequency in the system information as in below field description table while dl-ExplicitCarrierFreq indicates the NR ARFCN for the carrier frequency as given in the below description.

TABLE 3

FreqPriorityListNRSlicing field descriptions
FreqPriorityListNRSlicing
Indicates the list of frequency priority information
for frequencies. The 1^{st} entry in the
list corresponds to the current frequency
(referring SIB2), the 2^{nd} entry in the list
corresponds to the first frequency indicated by
the InterFreqCarrierFreqList in SIB4, and
the 3^{rd} entry in the list corresponds to the
second frequency indicated by the InterFreq-
CarrierFreqList in SIB4, and so on.
dl-ImplicitCarrierFreq
Indicates the downlink carrier frequency to
which sliceInfoList is associated which is
given implicitly in relation to the system
information. The 1st entry in the list
corresponds to the current frequency (referring-
to SIB2), the 2nd entry in the list
corresponds to the first frequency indicated
by the InterFreqCarrierFreqList in SIB4, and
the 3rd entry in the list corresponds to the
second frequency indicated by the InterFreq-
CarrierFreqList in SIB4, and so on.
dl-ExplicitCarrierFreq
DL NR-ARFCN of the downlink carrier to
which sliceInfoList is associated and is
explicitly provided.
sliceAllowCellListNR
Indicates the list of allow-listed neighbouring
cells for slicing. If present, cells not
listed in the list do not support the
corresponding sliceGroup-frequency pair.
sliceCellListNR
Indicates the list of allow-list or exclude-listed
neighbour cells for slicing. If sliceInfo-
r17 corresponds to the current frequency,
the field should be absent. FFS if the field
can be provided in RRCRelease.
sliceExcludeCellListNR
Indicates the list of exclude-listed neighbouring
cells for slicing. If present, cells not
listed in the list support the corresponding
slice sliceGroup-frequency pair.

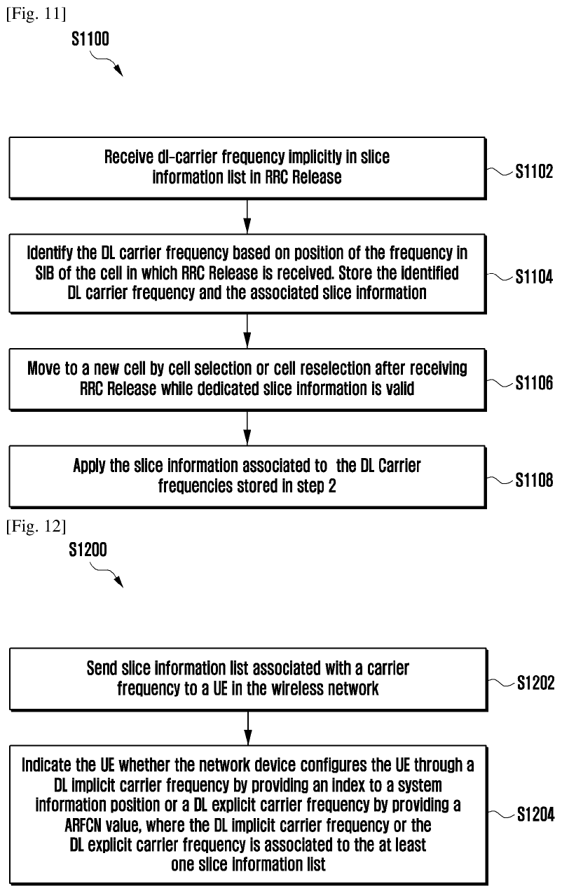

FIG. 11 is a flow chart (S1100) illustrating a scenario of handling of implicitly received DL Carrier Frequency in sliceinformation list, according to the embodiments as disclosed herein.

At S1102, the method includes receiving the dl-carrier frequency implicitly in the slice information list in the RRC Release. At S1104, the method includes identifying the DL carrier frequency based on position of the frequency in the SIB of the cell in which the RRC release is received. The method includes storing the identified DL carrier frequency and the associated slice information. At S1106, the method includes moving to the new cell by cell selection or cell reselection after receiving RRC release while dedicated slice information is valid. At S1108, the method includes applying the sliceinformation associated to the DL Carrier frequencies stored in step S1104.

In an embodiment, the gNB may configure implicit carrier frequency in the system information message and explicit carrier frequency in the RRC Release message. In an embodiment, the gNB configures the explicit carrier frequency when the sliceInfo contains slice groups which are associated with specific tracking areas.

In an alternate embodiment, when the UE (100) is configured with the implicit carrier frequency associated to the slice information list or when the UE (100) is not configured with any carrier frequency associated to the slice information list within the RRC Release message, the UE (100) maps the index value 0 to the current frequency (as in SIB2) of the cell which has send RRC Release. The index value of 1 indicates the first frequency indicated by the InterFreqCarrierFreqList in SIB4 of the cell which has send RRC Release. The index value of a value of 2 indicates the second frequency indicated by the InterFreqCarrierFreqList in SIB4 of the cell which has send RRC Release. The index value of 3 indicates the third frequency indicated by the InterFreqCarrierFreqList in SIB4 of the cell which has send RRC Release etc. The UE (100) stores the derived mapping between carrier frequency and slice information list, and uses the derived mapping during slice based cell reselection till the dedicated slice based priority is released. When the UE (100) selects a different cell or reselects to a different cell after RRC Release the derived mapping is stored.

In an embodiment, the UE (100) in the RRC_CONNECTED acquires the SIB2 and the SIB4 and ensures that the UE (100) has a valid system information while being in the RRC_CONNECTED when the UE (100) can receive slice information through the RRC Release.

FIG. 12 is a flow chart (S1200) illustrating a method for supporting cell reselection with slices in the wireless network (1000), according to the embodiments as disclosed herein. The operations (S1202 and S1204) are handled by the supporting cell reselection controller (240).

At S1202, the method includes sending the slice information list associated with the at least one carrier frequency to the UE (100) in the wireless network (1000). At S1204, the method includes indicating the UE whether the network device configures the UE through the DL implicit carrier frequency by providing an index to a system information position or a DL explicit carrier frequency by providing a ARFCN value. The DL implicit carrier frequency or the DL explicit carrier frequency is associated to the at least one slice information list.

The various actions, acts, blocks, steps, or the like in the flow charts (S200-S700 and S900-S1200) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a terminal in a wireless communication system, the method comprising:
receiving, from a base station, a system information block comprising first information indicating cell reselection priorities for slicing; and
determining a frequency for a cell reselection associated with a slice based on the first information,
wherein the first information indicates the frequency for the slice implicitly.

2. The method of claim 1,
wherein the first information indicating cell reselection priorities for slicing comprises second information indicating at least one frequency to which at least one slice is associated with, and
wherein the second information indicates a serving frequency or a frequency indicated by a frequency list in another system information block.

3. The method of claim 1,
wherein the determining the frequency for the cell reselection associated with the slice comprises:
receiving, from the base station, a radio resource control (RRC) release message comprising third information indicating the cell reselection priorities for slicing; and
determining the frequency for the cell reselection associated with the slice based on at least one of the first information or the third information,
wherein the third information indicates the frequency for the slice explicitly.

4. The method of claim 3,
wherein the third information comprises fourth information indicating at least one frequency to which at least one slice is associated.

5. A method performed by a base station in a wireless communication system, the method comprising:
generating a system information block comprising first information indicating cell reselection priorities for slicing; and
transmitting, to a terminal, the system information block comprising the first information indicating cell reselection priorities for slicing,
wherein a frequency for a cell reselection associated with a slice is determined based on the first information, and
wherein the first information indicates the frequency for the slice implicitly.

6. The method of claim 5,
wherein the first information indicating cell reselection priorities for slicing comprises second information indicating at least one frequency to which at least one slice is associated with, and
wherein the second information indicates a serving frequency or a frequency indicated by a frequency list in another system information block.

7. The method of claim 5, further comprising:
transmitting, to the terminal, a radio resource control (RRC) release message comprising third information indicating the cell reselection priorities for slicing,
wherein the frequency for the cell reselection associated with the slice is determined based on at least one of the first information or the third information, and
wherein the third information indicates the frequency for the slice explicitly.

8. The method of claim 7,
wherein the third information comprises fourth information indicating at least one frequency to which at least one slice is associated.

9. A terminal in a wireless communication system, the terminal comprising:
a transceiver; and
a controller coupled with the transceiver and configured to:
receive, from a base station, a system information block comprising first information indicating cell reselection priorities for slicing, and
determine a frequency for a cell reselection associated with a slice based on the first information,
wherein the first information indicates the frequency for the slice implicitly.

10. The terminal of claim 9,
wherein the first information indicating cell reselection priorities for slicing comprises second information indicating at least one frequency to which at least one slice is associated with, and
wherein the second information indicates a serving frequency or a frequency indicated by a frequency list in another system information block.

11. The terminal of claim 9,
wherein the determining the frequency for the cell reselection associated with the slice comprises:
receive, from the base station, a radio resource control (RRC) release message comprising third information indicating the cell reselection priorities for slicing, and
determine the frequency for the cell reselection associated with the slice based on at least one of the first information or the third information,
wherein the third information indicates the frequency for the slice explicitly.

12. The terminal of claim 11,
wherein the third information comprises fourth information indicating at least one frequency to which at least one slice is associated.

13. A base station in a wireless communication system, the base station comprising:
a transceiver; and
a controller coupled with the transceiver and configured to:
generate a system information block comprising first information indicating cell reselection priorities for slicing, and
transmit, to a terminal, the system information block comprising the first information indicating cell reselection priorities for slicing,
wherein a frequency for a cell reselection associated with a slice is determined based on the first information, and
wherein the first information indicates the frequency for the slice implicitly.

14. The base station of claim 13,
wherein the first information indicating cell reselection priorities for slicing comprises second information indicating at least one frequency to which at least one slice is associated with, and
wherein the second information indicates a serving frequency or a frequency indicated by a frequency list in another system information block.

15. The base station of claim 13, wherein the controller is further configured to:
transmit, to the terminal, a radio resource control (RRC) release message comprising third information indicating the cell reselection priorities for slicing,
wherein the frequency for the cell reselection associated with the slice is determined based on at least one of the first information or the third information,
wherein the third information indicates the frequency for the slice explicitly, and
wherein the third information comprises fourth information indicating at least one frequency to which at least one slice is associated.
